(19) United States
(12) Patent Application Publication
(10) Pub. No.: US 2015/0005040 A1
(43) Pub. Date: Jan. 1, 2015

(54) METHOD AND SYSTEM FOR SETTING PLURALITY OF SOUNDS THROUGH SOUND PACKAGE

(71) Applicant: Camp Mobile Corporation, Seoul (KR)

(72) Inventors: Jung Guk Kim, Seoul (KR); Seung Phill Lim, Seoul (KR)

(21) Appl. No.: 14/314,715

(22) Filed: Jun. 25, 2014

(30) Foreign Application Priority Data
Jun. 26, 2013 (KR) 10-2013-0073906

(51) Int. Cl. H04M 1/725; H04M 19/04

(52) U.S. Cl. CPC H04M 1/72563; H04M 19/04
USPC 455/567

(57) ABSTRACT

A method and system for setting a sound of a user terminal through a sound package include configuring, by a processor, at least two sound sources produced for different usages into a package and providing the package to a user terminal. The two sound sources in the package are employed for different usages at the user terminal and are set as the sound sources.

### CROSS-REFERENCE TO RELATED APPLICATION

This application claims priority from and the benefit of Korean Patent Application No. 10-2013-0073906, filed on Jun. 26, 2013, which is hereby incorporated by reference for all purposes as if fully set forth herein.

### BACKGROUND

Example embodiments relate to a technology for providing a sound source applicable to a user terminal and setting a sound of the user terminal through the sound source.

### DESCRIPTION OF THE BACKGROUND

A general sound source providing service may provide content capable of setting a ringtone, an alarm, and a notification sound, and may also provide a function that enables a user to determine a usage of an individual sound source and to set a desired sound source for each usage.

For example, Korean Patent No. 10-0403574, entitled “Ringtone download service method for mobile terminal and system thereof”, discloses a technology in which when a service providing server includes a plurality of ringtone files in a database and a user connects to the service providing server and then selects a desired ringtone file using a mobile communication terminal, the service providing server downloads corresponding files to the mobile communication terminal and subsequently, the user selects a single file from among the files stored in the mobile communication terminal and sets the selected file as a ringtone.

As described above, a conventional service employs a method that enables a user to verify a list of contents, to select and download desired content, and to set the downloaded content as a sound of a predetermined usage at a terminal

However, content provided from the existing service is provided as an individual sound source and accordingly, a user may need to independently perform an individual sound setting of a terminal through a sound source selected by the user. Accordingly, it may be difficult for the user to consistently set a sound for each usage of the terminal based on a theme desired by the user.

For example, when a user who likes singer PSY's “Gangnam style” is to set the overall sounds of a smartphone as the concept of “Gangnam style”, the user may need to purchase a sound source for each sound setting for each usage and apply the purchased sound source to a terminal, for example, (1) purchase a sound source for ringtone→change a ringtone of a terminal, (2) purchase a sound source for alarm→change an alarm of a terminal, and (3) purchase a sound source for notification sound→change a notification sound of a terminal

### SUMMARY

Example embodiments of the present invention provide a convenient function that enables a user to collectively set all the sounds of a terminal to be suitable for a predetermined theme.

Example embodiments also provide a package including sound sources corresponding to the same theme to be capable of setting a sound for each usage of a user terminal as a consistent concept.

Additional features of the example embodiments will be set forth in the description which follows, and in part will be apparent from the description, or may be learned by practice of the example embodiments.

Example embodiments disclose a method of providing a sound source, the method including configuring, by a processor, at least two sound sources produced for different usages into a package, and providing, by the processor, the package to a user terminal Here, at least two sounds used for different usages at the user terminal may be collectively set as sound sources included in the package.

The package may include sound sources classified based on the same theme.

The package may include sound sources available as a ringtone, a ring back tone, an alarm, and a notification sound.

The package may further include at least one image of a motion picture clip and a thumbnail image associated with a corresponding sound source with respect to each sound source.

The image may be played back at a point in time when a sound source set as a sound is executed at the user terminal

The providing of the package may include providing sound sources included in the package, based on a package unit, or providing a sound source selected by a user from among the sound sources included in the package, in an individual file format.

Example embodiments also disclose a method of setting a sound source, the method including storing, by a processor, a package including at least two sound sources produced for different usages, and collectively setting, by the processor, at least two sounds used for different usages at a user terminal, as sound sources included in the package.

Example embodiments also disclose a sound source providing system, including a configurer adapted to put into a package, at least two sound sources produced for different usages, and a provider configured to provide the package to a user terminal Here, at least two sounds used for different usages at the user terminal may be collectively set as sound sources included in the package.

Example embodiments also disclose a sound source setting apparatus, including a storage configured to store a package including at least two sound sources produced for different usages, and a setter configured to collectively set at least two sounds used for different usages at a user terminal as sound sources included in the package.

Example embodiments also disclose non-transitory computer-readable storage media including instructions to control a setting of a sound source by a computer system, wherein the instructions control the computer system by a method including storing a package including at least two sound sources produced for different usages, and collectively setting at least two sounds used for different usages at a user terminal as sound sources included in the package.

Example embodiments also disclose a file distribution system for distributing a file of an application to be installed in a user terminal, the file distribution system including a file transmitter configured to transmit the file in response to a request of the user terminal Here, the application may include a module configured to provide, to the user terminal, a package including at least two sound sources produced for different usages, and a module configured to collectively set at least two sounds used for different usages at the user terminal, as sound sources included in the package.

It is to be understood that both the foregoing general description and the following detailed description are explanatory and are intended to provide further explanation of the example embodiments as claimed.

According to example embodiments, it is possible to enhance user convenience for sound setting by collectively setting sounds, for example, a ringtone, a ring back tone, an alarm, and a notification sound, used at a user terminal through a package including sound sources for different usages.

According to example embodiments, it is possible to experience sound related functions of a terminal based on a consistent theme by providing, as a package, sound sources classified based on a theme and by collectively changing sounds for a variety of usages used at a user terminal, as sound sources of the same theme.

### BRIEF DESCRIPTION OF THE DRAWINGS

The accompanying drawings, which are included to provide further understanding of the example embodiments and are incorporated in and constitute a part of this specification, illustrate example embodiments, and together with the description serve to explain the principles of the example embodiments.

FIG. 1 illustrates an example of a relationship between a user terminal and a sound source providing system according to an example embodiment.

FIG. 2 is a block diagram illustrating a configuration of a sound source providing system according to an example embodiment.

FIGS. 3 through 5 illustrate examples of a service screen for setting a sound according to example embodiments.

FIG. 6 is a block diagram illustrating a configuration of a sound source setting apparatus configured on a user terminal according to an example embodiment.

FIG. 7 illustrates an example of an incoming call screen of a user terminal according to an example embodiment.

FIG. 8 is a flowchart illustrating a sound source providing method for providing a sound package at a sound source providing system according to one example embodiment.

FIG. 9 is a flowchart illustrating a sound source setting method for setting a sound of a user terminal through a sound package according to an example embodiment.

### DETAILED DESCRIPTION OF EXAMPLE EMBODIMENTS

The invention is described more fully hereinafter with reference to the accompanying drawings, in which example embodiments are shown. This invention may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and areas may be exaggerated for clarity. Like reference numerals in the drawings denote like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described with reference to the accompanying drawings.

In the present specification, the term “sound” refers to all the auditory elements expressed on a user terminal in order to notify a user about a terminal state or predetermined information, such as a ringtone, a ring back tone, an alarm, a morning call, a push notification such as an incoming message sound and an incoming messenger sound, and a notification sound such as a variety of reaction notifications, for example. The morning call may be an alarm message which wakes up the user at a predetermined time.

The term “user terminal” refers to any type of terminals configured to provide a sound setting function, such as a smartphone, a tablet, a laptop computer, a digital broadcasting terminal, a portable multimedia player (PMP), and a navigation terminal, for example.

Herein, proposed is a technology capable of collectively setting and changing sounds used at a user terminal

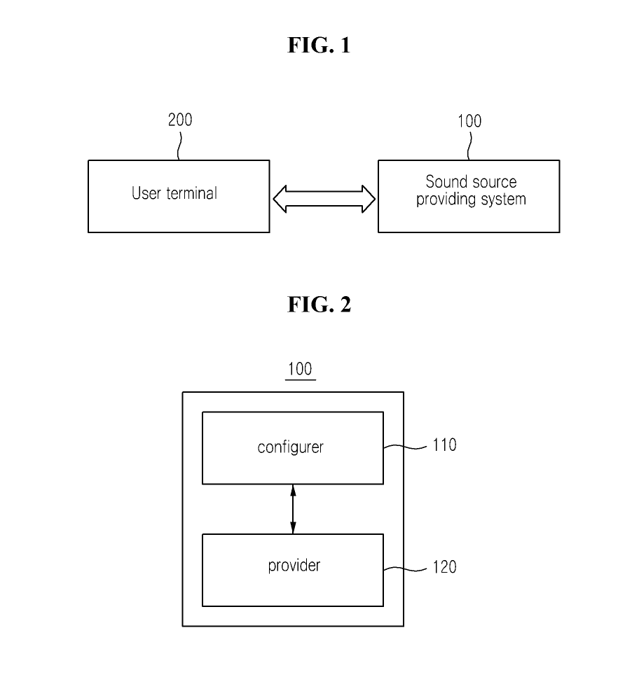

FIG. 1 illustrates an example of a relationship between a user terminal 200 and a sound source providing system 100. Referring to FIG. 1, an arrow indicator shows that data is transmittable and receivable between the sound source providing system 100 and the user terminal 200 over a wired/wireless network.

The sound source providing system 100 serves as a service platform to provide content capable of setting a ringtone, a ring back tone, an alarm, a morning call, and a variety of notification sounds (hereinafter, also referred to as a “sound”) of the user terminal 200. In this example, the sound source providing system 100 configures, into a sound package, a plurality of sound sources produced for a ringtone, a ring back tone, an alarm, a morning call call, and a notification sound, and provides the sound package to be collectively purchased and used for setting sounds for a plurality of usages.

The sound source providing system 100 may be configured to interact with a database system configured to store and maintain sound sources registered from a sound source provider or may be configured in a form in which the sound source providing system 100 and the database system are merged into a single system. Accordingly, the sound source providing system 100 may embody a profit distributive service model for providing a sound package to a user, and distributing profits earned from the sound package to the sound source provider.

The user terminal 200 refers to any type of mobile devices capable of connecting to a website/mobile site associated with the sound source providing system 100, or installing and executing a service exclusive application. Here, the user terminal 200 performs the overall operation required for a service through the website/mobile site or the service exclusive application, such as a configuration of a service screen, data input, data transmission and reception, and data storage, for example. In particular, the user terminal 200 serves as a publisher to expose the sound package provided from the sound source providing system 100 through the website/mobile site or the service exclusive application, and may also be an entity that directly uses the sound package.

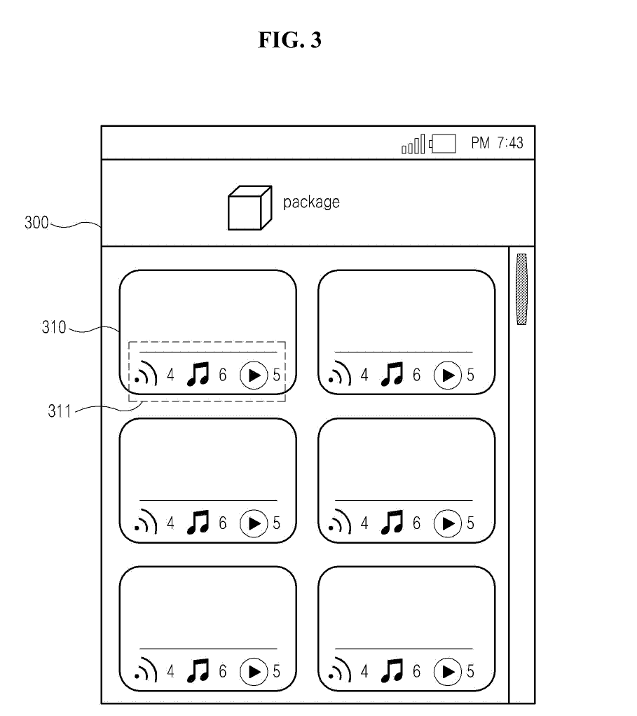

FIG. 2 is a block diagram illustrating a configuration of the sound source providing system 100 according to one example embodiment. Referring to FIG. 2, the sound source providing system 100 includes a configurer 110 and a provider 120.

The configurer 110 serves to configure, into a sound package, at least two sound sources produced for different usages. The configurer 110 may configure a sound package using a variety of contents such as music albums, games, movies, and characters maintained by the sound source providing system 100 or stored in a database interoperable therewith. Here, sound sources to be included in the sound package may indicate a sound clip that is a partial section clipped from content based on a usage of a sound at a user terminal.

As an example, the configurer 100 may configure a sound package using sound sources for the respective usages at the user terminal, for example, a sound source for ringtone, a sound source for alarm, and a sound source for notification sound. In detail, the configurer 110 may include, in the sound package, at least one sound source of one minute or less to be used for ringtone, at least one sound source of one minute or less to be used for alarm, and at least one sound source of five seconds or less to be used for notification sound.

As another example, the configurer 110 may configure a sound package by further including at least one image of a motion picture clip and a thumbnail image associated with a corresponding sound source included in the sound package. In this example, the image may refer to video data that is played back at a point in time when a sound source set as a sound at the user terminal is played back, or that is displayed when the sound package is exposed on the user terminal In detail, the configurer 110 may configure the sound package by additionally including at least one motion picture clip of one minute or less that is played back at a playback point in time of a ringtone, at least one motion picture clip of one minute or less that is played back at a playback point in time of an alarm, and a thumbnail image or an icon for promotion or introduction of the sound package.

As another example, the configurer 110 may configure a sound package using sound sources classified based on the same theme. That is, the configurer 110 may configure the sound package using sound sources having a common theme, such as a character, a celebrity, a game, and an album. In detail, the configurer 110 may configure the sound package using sound sources classified based on a variety of standards, such as configuring a single sound package using sound sources clipped for each usage in predetermined music, configuring a single sound package using sound sources clipped for each usage in songs of a predetermined singer, configuring a single sound package using sound sources clipped for each usage in songs of a predetermined genre, and configuring a single sound package using sound sources clipped for each usage in songs containing a predetermined message, for example, for a birthday, Christmas, and a New Year.

The provider 120 serves to provide the sound package to the user terminal As an example, the provider 120 may expose a sound package through a service exclusive application (app) installed in the user terminal, or may expose the sound package through an interoperable website/mobile site or its own company. As another example, the provider 120 may register a sound package to an app store as an individual app and may provide the sound package to the user for payment or for free. In this example, the provider 120 may provide, based on a package unit, images and sound sources that are classified based on a predetermined theme and produced for a variety of usages, and in response to a request of the user, may also provide, in an individual file format, a sound source and an image that are selected by the user from the sound package. The provider 120 may provide a service of downloading the sound package to the user terminal through a communication channel of the service exclusive app or the website/mobile site.

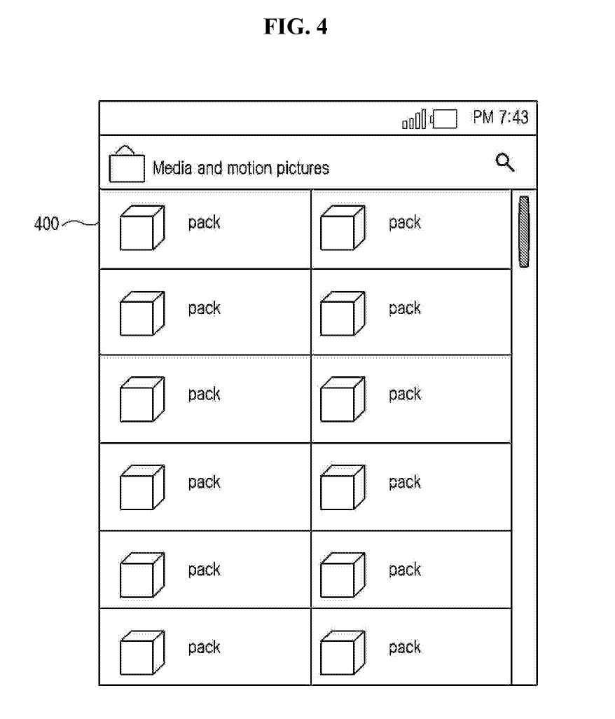

According to example embodiment, a user may search for and purchase a sound package provided from a sound source providing system, using a user terminal For example, referring to FIG. 3, the sound source providing system 100 may provide a sound package list 300 through a service exclusive app installed in the user terminal In this example, a thumbnail image (not shown) for introducing a corresponding sound package 310 and brief information 311, for example, four sound sources for notification sound, six sound sources for ringtone/alarm, and five motion picture clips for ringtone/alarm, on sound sources included in the sound package 310 may be displayed for each sound package 310. As another example, referring to FIG. 4, the sound source providing system 100 may provide a sound package list 400 registered as an individual app through app store media configured to store mobile apps. Similarly, a thumbnail image and brief information of a corresponding sound package may be displayed for each sound package included in the sound package list 400. In this example, search for and purchase of a sound package may be performed on an exclusive app. Alternatively, purchase of a sound package may be performed by moving from a service exclusive app to an app store when a user is to purchase the sound package.

Accordingly, a user may select a predetermined sound package from a sound package list and may verify sound sources and images included in the selected sound package.

FIG. 5 illustrates an example of a package verification screen 500 for verifying detailed information of a sound package according to an example embodiment. For example, referring to FIG. 5, a thumbnail image (not shown) for introducing a corresponding sound package and a list 510 of sound sources for ringtone/alarm, a list 520 of motion picture clips for ringtone/alarm, and a list 530 of sound sources for notification sound may be displayed on the package verification screen 500. A user may individually verify, from each of the lists 510, 520, and 530, sound sources and images for each usage included in the sound package. Further, various types of menus associated with a service may be activated and thereby displayed on the package verification screen 500. The various types of menus may include, for example, a menu for purchasing and downloading a selected sound package, a menu for setting a sound of a user terminal using the selected sound package, and a menu for sharing a selected sound through a mail service, a messenger service, a social network service, a wireless transmission function, and a memo function.

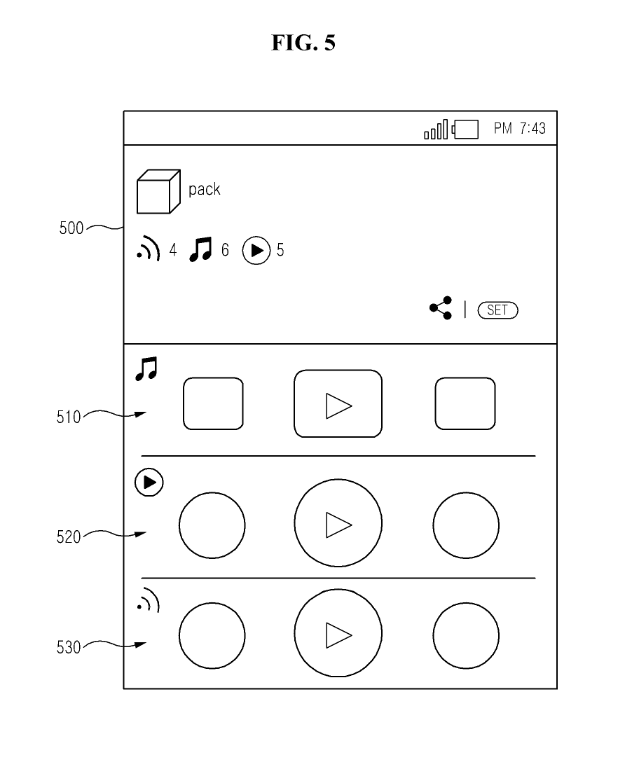

FIG. 6 is a block diagram illustrating a configuration of a sound source setting apparatus 205 configured on a user terminal 200 according to one example embodiment. Referring to FIG. 6, the sound source setting apparatus 205 includes a storage 210 and a setter 220. The sound source setting apparatus 205 may be embodied on a user terminal that is an entity for using a sound package.

The storage 210 serves to store a sound package including sound sources for a variety of usages. That is, the storage 210 stores and maintains a sound package downloaded from a sound source providing system 100 by a user to use as a sound of the user terminal 200.

The setter 220 collectively sets, as sound sources included in the sound package, at least two sounds used for different usages at the user terminal 200. As an example, the setter 220 may collectively change settings of sounds such as a ringtone, an alarm, and a notification sound of the user terminal, using sound sources selected by the user from the sound package. In addition, the setter 220 may set a video clip included in the sound package, as a sound image that is played back at a playback point in time of ringtone/alarm at the user terminal. Here, in a case in which at least two sound sources or at least two video clips for each usage are included in a single sound package, the setter 220 may receive a selection from the user on a target to be selected as a sound or a sound image of the user terminal 200 and may set the selected sound or sound image. Accordingly, the storage 210 may store index values corresponding to a sound source set as a sound of the user terminal 200 and a video clip set as a sound image of the user terminal among sound sources and images included in the sound package.

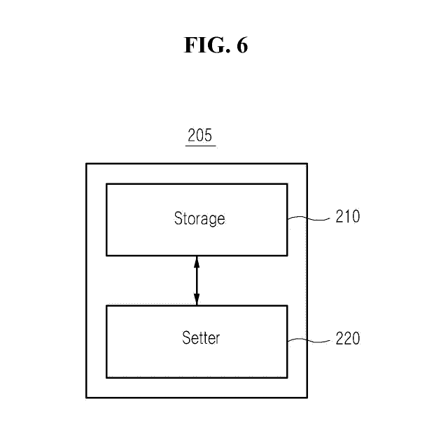

In response to a detection of an event, for example, an incoming call signal, an incoming message signal, and an alarm occurrence signal, that requires sound output, the user terminal 200 outputs a sound for usage corresponding to the corresponding signal. In this instance, the user terminal simultaneously plays back a sound source set as a sound and a video clip set as a sound image. FIG. 7 illustrates an example of an incoming call screen 700 of a user terminal 200 according to an example embodiment. Referring to FIG. 7, in response to an incoming call, the user terminal 200 simultaneously plays back a video clip 702 and a sound source 701 set as a ringtone with respect to a corresponding signal.

According to example embodiments, it is possible to collectively set a plurality of sounds of a user terminal 200 using sound sources included in a sound package by providing the sound package including sound sources for a variety of usages.

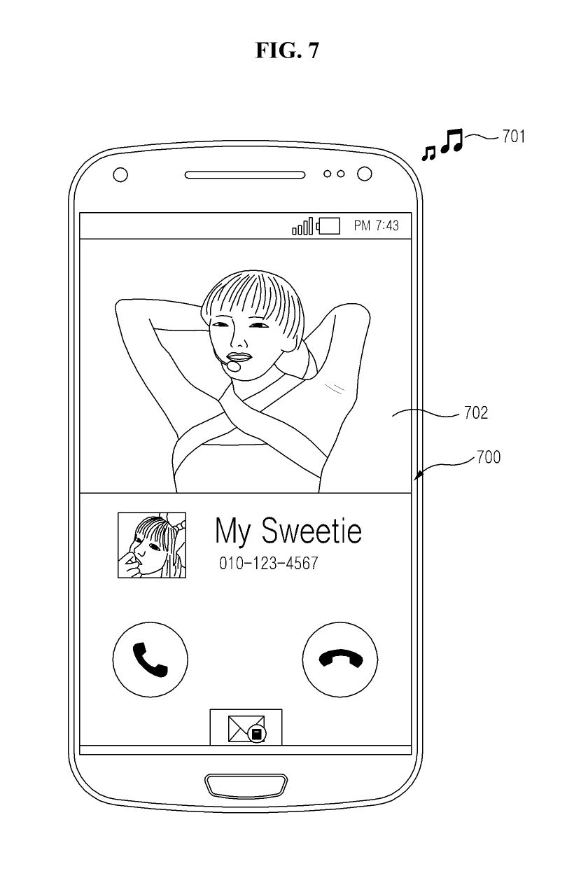

FIG. 8 is a flowchart illustrating a sound source providing method for providing a sound package at a sound source providing system 100 according to an example embodiment.

In operation S810, the sound source providing system 100 configures, into a sound package, at least two sound sources produced for different usages. Here, the sound sources to be included in the sound package may indicate a sound clip that is a partial section clipped from content based on a usage of a sound used at a user terminal 200. As an example, the sound source providing system 100 may configure a sound package using sound sources for the respective usages at the user terminal 200, for example, a sound source for ringtone, a sound source for alarm, and a sound source for notification sound. As another example, the sound source providing system 100 may configure a sound package by further including at least one image of a motion picture clip and a thumbnail image associated with a sound source included in the sound package. In this example, the image may refer to video data that is played back at a point in time when a sound source set as a sound at the user terminal 200 is played back, or that is displayed when the sound package is exposed on the user terminal As another example, the sound source providing system 100 may configure a sound package using sound sources classified based on the same theme. That is, the sound source providing system 100 may configure the sound package using sound sources having a common theme, such as a character, a celebrity, a game, and an album.

In operation S820, the sound source providing system 100 provides the sound package to the user terminal 200. As an example, the sound source providing system 100 may expose a sound package through a service exclusive app installed in the user terminal, or may expose a sound package through an interoperable website/mobile site. As another example, the sound source providing system 100 may register a sound package to an app store as an individual app and may provide the sound package to a user for payment or for free. In this example, the sound source providing system 100 may provide, based on a package unit, images and sound sources that are classified based on a predetermined theme and produced for a variety of usages. In addition, in response to a request of the user, the sound source providing system 100 may provide, in an individual file format, an image and a sound source that are selected by a user from the sound package. The sound source providing system 100 may provide a service of downloading the sound package to the user terminal 200 through a communication channel of a service exclusive app or a website/mobile site.

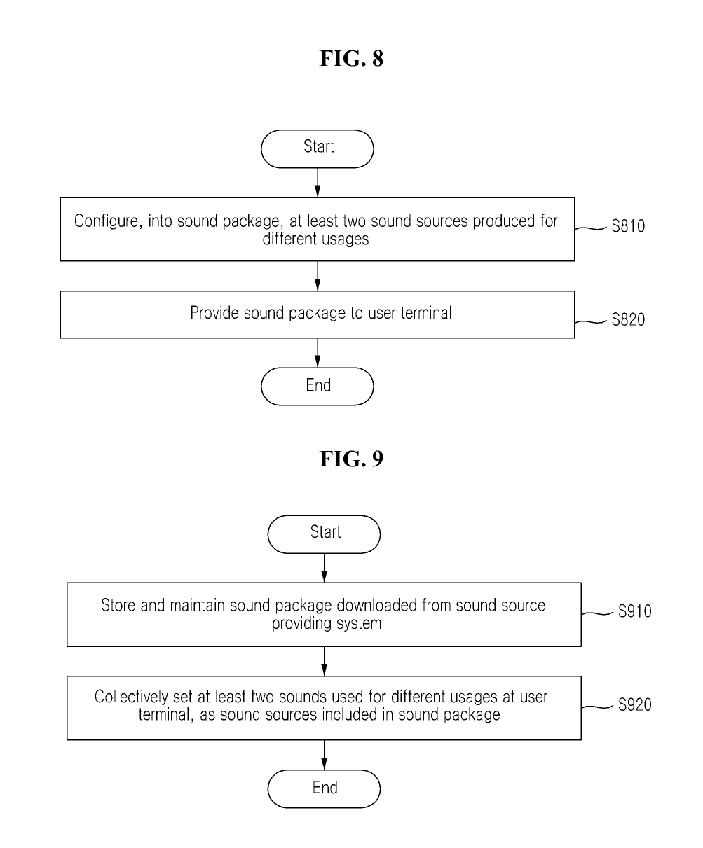

FIG. 9 is a flowchart illustrating a sound source setting method for setting a sound of a user terminal 200 through a sound package according to an example embodiment. The sound source setting method of FIG. 9 may be performed by a sound source setting apparatus 205 of FIG. 6.

In operation S910, the sound source setting apparatus 205 stores and maintains a sound package downloaded from a sound source providing system 100 by a user in order to use as a sound of a user terminal 200.

In operation S920, the sound source setting apparatus 205 collectively sets at least two sounds used for different usages at the user terminal, as sound sources included in the sound package. As an example, the sound source setting apparatus 205 may collectively change settings of sounds such as a ringtone, an alarm, and a notification sound of the user, using sound sources selected by the user from the sound package. In addition, the sound source setting apparatus 205 may set a video clip included in the corresponding sound package, as a sound image that is played back at a playback point in time of a ringtone/alarm at the user terminal Here, in a case in which at least two sound sources or at least two video clips for each usage are included in a single sound package, the sound source setting apparatus 205 may receive a selection from the user on a target to be set as a sound or a sound image of the user terminal 200 and may set the selected sound or sound image. Accordingly, the sound source setting apparatus 205 stores index values corresponding to a sound source set as a sound of the user terminal 200 and a video clip set as a sound image of the user terminal among sound sources and images included in the sound package.

Accordingly, the user terminal 200 may collectively change sounds for various usages using sound sources of the same theme provided as a sound package. Also, in response to a detection of an event, for example, an incoming call signal, an incoming message signal, and an alarm occurrence signal, that requires sound output, the user terminal 200 may output a sound provided in the sound package for usage corresponding to the detected event. In this instance, the user terminal would simultaneously play back a sound source set as a sound and a video clip set as a sound image.

The aforementioned sound source providing method and sound source setting method may include further reduced operations or additional operations, based on the detailed description related to the sound source providing system and the sound source setting apparatus described above with reference to FIGS. 1 through 7. Also, at least two operations may be combined with each other and orders or positions of operations may be changed.

Methods according to the example embodiments may be configured in a form of instructions executable through a variety of computer systems and may be recorded in non-transitory computer-readable media. In particular, the example embodiments may include non-transitory computer-readable media storing a program including storing a sound package including at least two sound sources produced for different usages; and collectively setting at least two sounds used for different usages at a user terminal, as sound sources included in the sound package.

The program according to the example embodiments may be configured as a PC-based program or an application exclusive for a mobile terminal. An app for providing a sound package according to example embodiments may be configured in a form of an independently operating program or an in-app form of a predetermined application, for example, a ringtone program and an app store program, and thereby, configured to be operable on the predetermined application.

Also, the methods according to the example embodiments may be performed in such a manner that an application associated with a server system configured to provide content available as a sound of a user terminal controls the user terminal As an example, the application may include a module configured to provide, to the user terminal, a sound package including at least two sound sources produced for different usages, and a module configured to collectively set at least two sounds used for different usages at the user terminal, as the sound sources included in the sound package. The application may be installed in the user terminal through a file provided from a file distribution system. For example, the file distribution system may include a file transmitter (not shown) configured to transmit the file in response to a request of a user.

As described above, according to the example embodiments, it is possible to enhance user convenience for sound setting by collectively setting sounds, for example, a ringtone, a ring back tone, an alarm, and a notification sound, used at a user terminal through a package including sound sources for different usages. Also, according to the example embodiments, it is possible to experience sound related functions of a terminal based on a consistent theme by providing, as a package, sound sources classified based on a theme and by collectively changing sounds for a variety of usages used at a user terminal, as sound sources of the same theme.

The source providing system 100 and the sound source setting apparatus 205 described herein may be implemented using hardware components, software components, or a combination thereof. For example, they may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The software implementing the present invention may include a computer program, a piece of code, an instruction, or some combination thereof, for independently or collectively instructing or configuring a processing or computing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. A method of providing a sound source in a user terminal, the method comprising:
configuring, by a processor, at least two sound sources produced for different usages into a package; and
providing, by the processor, the package to the user terminal,
wherein the at least two sound sources in the package are set as sound sources for at least two sounds used for different usages at the user terminal

2. The method of claim 1, wherein the package comprises sound sources classified based on the same theme.

3. The method of claim 1, wherein the package comprises sound sources available as a ringtone, a ring back tone, an alarm, and a notification sound.

4. The method of claim 1, wherein the package further comprises at least one image of a motion picture clip and a thumbnail image associated with a corresponding sound source with respect to each sound source.

5. The method of claim 4, wherein the image is played back at a point in time when a sound source set as a sound is executed at the user terminal

6. The method of claim 1, wherein the providing of the package comprises providing the sound sources in the package, based on a package unit, or providing a sound source selected by a user from among the sound sources in the package, in an individual file format.

7. A method of setting a sound source in a user terminal, the method comprising:
storing, by a processor, a package comprising at least two sound sources produced for different usages; and
setting, by the processor, the at least two sound sources in the package as sound sources for at least two sounds used for different usages in the user terminal.

8. The method of claim 7, wherein the package comprises sound sources classified based on the same theme.

9. The method of claim 7, wherein the package comprises sound sources available as a ringtone, a ring back tone, an alarm, and a notification sound.

10. The method of claim 7, wherein the package further comprises at least one image of a motion picture clip and a thumbnail image associated with a corresponding sound source with respect to each sound source.

11. The method of claim 10, wherein the image is played back at a point in time when a sound source set as a sound is executed at the user terminal

12. The method of claim 7, wherein the sound sources in the package are provided based on a package unit, or a sound source selected by a user from among the sound sources in the package is provided in an individual file format.

13. Non-transitory computer-readable storage media storing instructions to control a setting of a sound source in a user terminal, wherein the instructions control a processor to execute functions comprising:
storing a package comprising at least two sound sources produced for different usages; and
setting the at least two sound sources in the package as sound sources for at least two sounds used for different usages in the user terminal

14. The non-transitory computer-readable storage media of claim 13, wherein the package comprises sound sources classified based on the same theme.

15. The non-transitory computer-readable storage media of claim 13, wherein the package comprises sound sources available as a ringtone, a ring back tone, an alarm, and a notification sound.

16. The non-transitory computer-readable storage media of claim 13, wherein the package further comprises at least one image of a motion picture clip and a thumbnail image associated with a corresponding sound source with respect to each sound source.

17. The non-transitory computer-readable storage media of claim 16, wherein the image is played back at a point in time when a sound source set as a sound is executed at the user terminal.

18. The non-transitory computer-readable storage media of claim 13, wherein the sound sources in the package are provided based on a package unit, or a sound source selected by a user from among the sound sources in the package is provided in an individual file format.
